(19) United States
(12) Patent Application Publication
(10) Pub. No.: US 2012/0211481 A1
(43) Pub. Date: Aug. 23, 2012

(54) TOWEL RACK

(76) Inventor: Shun-Hui HUANG, Taichung City (TW)

(21) Appl. No.: 13/030,747

(22) Filed: Feb. 18, 2011

(51) Int. Cl. H05B 1/00

(52) U.S. Cl. 219/213

(57) ABSTRACT

A towel rack includes: two upstanding hollow posts, each being generally U-shaped in cross section and including two side plate portions and an intermediate plate portion interconnecting the two side plate portions, the two side plate portions cooperatively defining a substantially vertical elongate opening; at least one hollow hanging bar having an inner space therein and two end portions; a fastening unit detachably connecting each of the two end portions of the hollow hanging bar to one of the side plate portions of a respective one of the hollow posts; and an electric heater including a heating wire inserted in the inner space of the hollow hanging bar so that the hollow hanging bar can be heated via the heating wire.

### BACKGROUND OF THE INVENTION

1. Field of the Invention

This invention relates to a towel rack, more particularly to a towel rack that can be assembled with relative ease.

2. Description of the Related Art

Referring to FIG. 1a, a conventional towel rack 6 includes two upright rods 61 and a plurality of hanging bars 62 disposed between the upright rods 61. If the upright rods 61 and the hanging bars 62 are hollow, the towel rack 6 may further include an electric heating system (not shown) including a heating wire 63 inserted in inner spaces of the upright rods 61 and the hanging bars 62. The electric heating system is provided for heating the hanging bars 62 so as to be able to heat a towel hung thereon.

Generally, the upright rods 61 and the hanging bars 62 of the conventional towel rack 6 are fastened to each other by welding. However, referring to FIGS. 1a and 1b, individual consumers may require different configurations for the hanging bars 62 of the towel rack in accordance with specific requirements. A conventional welded towel rack 6 is not adjustable and thus cannot meet consumers' requirements.

### SUMMARY OF THE INVENTION

Therefore, the object of the present invention is to provide a towel rack that can be assembled with relative ease.

According to the present invention, a towel rack comprises: two upstanding hollow posts, each being generally U-shaped in cross section and including two side plate portions and an intermediate plate portion interconnecting the two side plate portions, the two side plate portions cooperatively defining a substantially vertical elongate opening; at least one hollow hanging bar having an inner space therein and two end portions; a fastening unit detachably connecting each of the two end portions of the hollow hanging bar to one of the side plate portions of a respective one of the hollow posts; and an electric heater including a heating wire inserted in the inner space of the hollow hanging bar so that the hollow hanging bar can be heated via the heating wire.

### BRIEF DESCRIPTION OF THE DRAWINGS

Other features and advantages of the present invention will become apparent in the following detailed description of the preferred embodiment of the invention, with reference to the accompanying drawings, in which:

FIGS. 1a and 1b are perspective views of conventional welded towel racks;

FIG. 2 is an exploded perspective view of the preferred embodiment of a towel rack according to this invention;

FIG. 3 is a perspective view of the preferred embodiment of a towel rack according to this invention; and

FIG. 4 is a perspective view of the preferred embodiment of a towel rack according to this invention, showing a different assembled configuration of the towel rack.

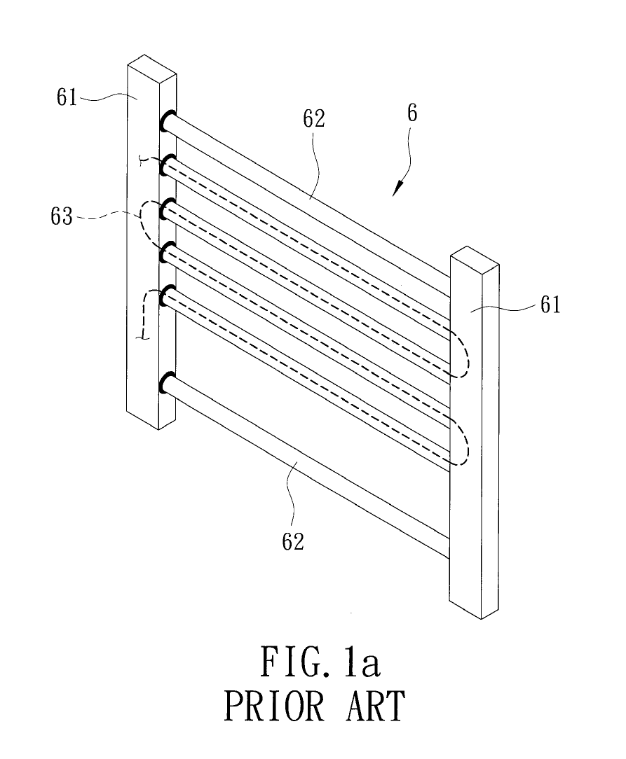

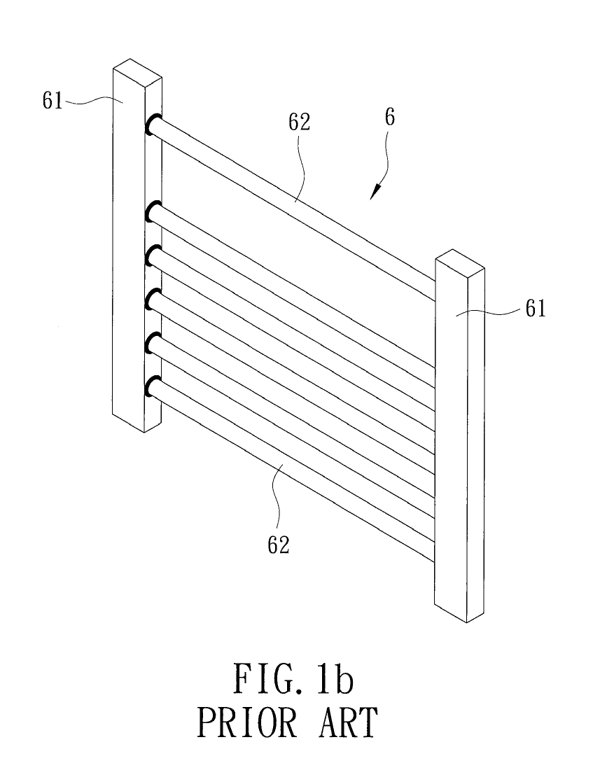

### DETAILED DESCRIPTION OF THE PREFERRED EMBODIMENT

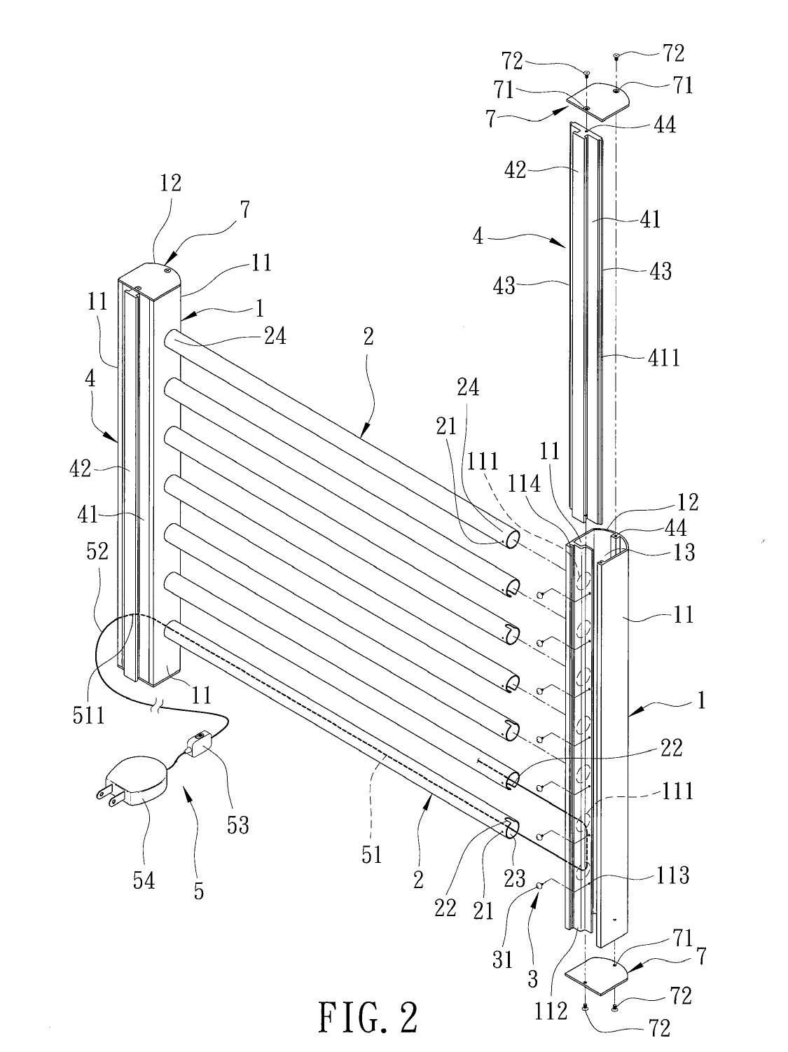

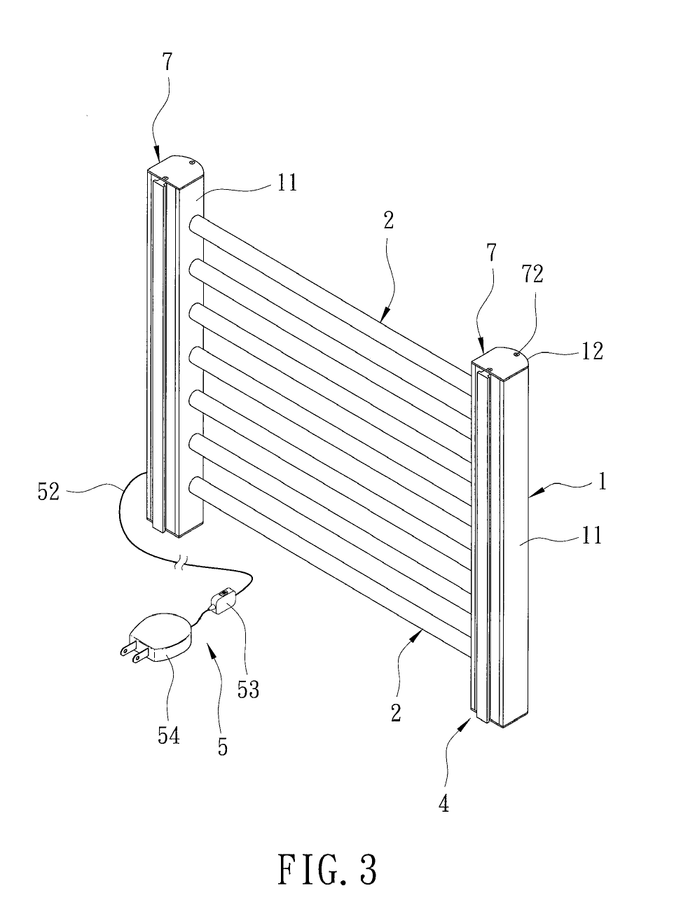

Referring to FIGS. 2 and 3, the preferred embodiment of a towel rack of the present invention comprises: two upstanding hollow posts 1, each being generally U-shaped in cross section and including two side plate portions 11 and an intermediate plate portion 12 interconnecting the two side plate portions 11; seven hollow hanging bars 2 each of which has an inner space 23 therein and two end portions 24; a fastening unit 3 detachably connecting each of the two end portions 24 of each of the hollow hanging bars 2 to one of the side plate portions 11 of a respective one of the hollow posts 1; and an electric heater 5 including a heating wire 51 inserted in the inner space 23 of each of the hollow hanging bars 2 so that the hollow hanging bars 2 can be heated via the heating wire 51.

The two side plate portions 11 of each of the hollow posts 1 cooperatively define a substantially vertical elongate opening 13. The one of the side plate portions 11 of each of the hollow posts 1 connected to the hollow hanging bars 2 includes seven through holes 111 and a flange plate 112 that is proximate to the elongate opening 13 and that protrudes into the respective one of the hollow posts 1. The flange plate 112 is formed with seven first fastening holes 113. It should be noted that both of the numbers of the through holes 111 and the first fastening holes 113 are not limited to seven.

Each of the end portions 24 of each of the hollow hanging bars 2 is formed with a second fastening hole 21 and a notch 22, and extends through one of the through holes 111 of the side plate portion 11 of a respective one of the hollow posts 1 and is firmly connected to a respective one of the flange plates 112 via the fastening unit 3. The notch 22 of each of the hollow hanging bars 2 is for engaging the heating wire 51 of the electric heater 5.

Preferably, the uppermost and the lowermost hanging bars 2 are formed with merely one notch 22 on one of the end portions 24 thereof, while each of the other hanging bars 2 disposed between the uppermost and the lowermost hanging bars 2 has two notches 22 respectively formed on each of the end portions 24 thereof. It should be noted that the number of the hollow hanging bars 2 is not limited to seven and may vary in accordance with actual requirements. Preferably, the hanging bars 2 are made from steel that has superior strength for maintaining dimensional stability and preventing deformation. Alternatively, the hanging bars 2 may be made from any other thermal conductive materials.

In this embodiment, the fastening unit 3 includes a plurality of screw 31 and nut (not shown) assemblies. Each of the screws 31 is inserted into one of the second fastening holes 21 formed on a respective one of the hanging bars 2 and one of the first fastening holes 113 formed on the flange plate 112 of a corresponding one of the hollow posts 1. The number of the screw 31 and nut assemblies corresponds to the number of the hanging bars 2 that are to be secured to the hollow posts 1, e.g., the number of the fastening unit 3 is also seven in the preferred embodiment of the present invention. Alternatively, any other type of fastener that is able to tightly engage each of the two end portions 24 of each of the hollow hanging bars 2 to one of the side plate portions 11 of the respective one of the hollow posts 1 can be used.

Preferably, the electric heater 5 includes a heating wire 51, an electric wire 52, a switch 53, and a plug 54. The heating wire 51 is firstly inserted into the inner space 23 of the lowermost hollow hanging bar 2 through one of the through holes 111 of a respective one of the hollow posts 1, and then passes through the inner spaces 23 of the other hanging bars 2 while engaging the notches 22 formed on the end portions 24 of the hanging bars 2. The electric wire 52 is connected to one end 511 of the heating wire 51. It should be noted that, in use, the end 511 of the heating wire 51 that is connected to the electric wire 52 should remain in the inner space 23 of the lowermost hanging bar 2 or in the hollow post 1 for safety considerations. When the plug 54 is connected to a socket (not shown) and the switch 53 is turned on, the heating wire 51 of the electric heater 5 is heated such that the electric heater 5 is able to heat the hanging bars 2 and a towel hung thereon.

Preferably, the preferred embodiment of the towel rack of the present invention further comprises two substantially vertical lids 4, each spanning the elongate opening 13 of a respective one of the hollow posts 1. Each of the vertical lids 4 includes a lidplate 41 disposed between and engaging slidably the side plate portions 11 of the respective one of the hollow posts 1 to cover the elongate opening 13 of the respective one of the hollow posts 1, and a handling portion 42 projecting transversely from the lid plate 41 and outwardly from the elongate opening 13 of the respective one of the hollow posts 1. The handling portion 42 is operable to slide the lid plate 41 vertically relative to the side plate portions 11 of the respective one of the hollow posts 1 and to uncover the elongate opening 13 of the respective one of the hollow posts 1.

The vertical lid plate 42 of each of the vertical lids 4 includes two first slide members 411, and each of the side plate portions 11 of each of the hollow posts 1 includes a second slide member 114. The first slide members 411 of each of the vertical lid plates 41 slidably and respectively engages the second slide members 114 of the side plate portions 11 of a corresponding one of the hollow posts 1. Particularly, one of the first and second slide members 411, 114 is a male slide member, and the other one of the first and second slide members 411, 114 is a female slide member.

Preferably, each of the vertical lid plates 41 has two vertical ends 43. In the preferred embodiment of this invention, as shown in FIG. 2, each of the first slide members 411 is a slide ridge, i.e., the male slide member, formed at a respective one of the two vertical ends 43 of a respective one of the vertical lids 4. Each of the second slide members 114 is a slide groove, i.e., the female slide member, formed proximate to the elongate opening 13 of a respective one of the hollow posts 1.

More preferably, each of the hollow posts 1 further includes two cover plates 7 to respectively cover top and bottom open ends thereof. As shown in FIGS. 2 and 3, each of the cover plates 7 may be formed with a plurality of first screw holes 71, and each of the hollow posts 1 and each of the vertical lids 4 may be formed with a plurality of second screw holes 44. Each of the cover plates 7 may be fastened to a respective one of the hollow posts 1 and a respective one of the vertical lids 4 by a plurality of screws 72 that pass through the first and second screw holes 71, 44. Alternatively, the cover plates 7 may be fastened to the respective one of the hollow posts 1 and the respective one of the vertical lids 4 by any other fastener known to one skilled in the art. The numbers of the first and second screw holes 71, 44 and the fasteners are not limited. Meanwhile, by virtue of the cover plates 7, undesired contact with the heating wire 51 in the hanging bars 2 and the hollow posts 1 can be avoided.

During assembly, each of the two end portions 24 of each of the hollow hanging bars 2 is extended into one of the through holes 111 of the side plate portion 11 of a respective one of the hollow posts 1, followed by firmly fastening each of the hanging bars 2 to the flange plate 112 of the one of the side plate portions 11 of the respective one of the hollow posts 1 using the fastening unit 3. The heating wire 51 is then inserted into the inner space 23 of each of the hanging bars 2 through the respective through hole 111 while engaging the notch 22 of each of the hanging bars 2 so as to be secured thereon. Each of the vertical lids 4 engages with the respective one of the hollow posts 1 via the first and second slide members 411, 114. Subsequently, the cover plates 7 are fastened to the hollow posts 1 and the vertical lids 4.

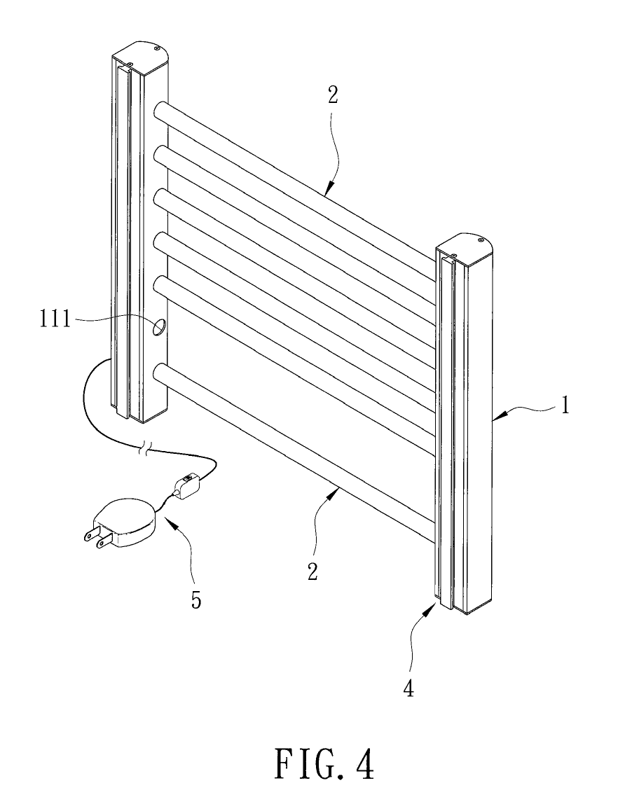

By extending the hanging bars 2 through the through holes 111 of the side plate portions 11 and connecting the same to the hollow posts 1 using the fastening unit 3, the towel rack of the present invention may be assembled conveniently and quickly. Referring to FIG. 4, a different configuration for the towel rack may be easily accomplished by dispensing with one or more hanging bars 2 such that the towel rack may conform to different requirements. Moreover, the hollow posts 1 and the hollow hanging bars 2 are easily manufactured and are suitable for mass production.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A towel rack comprising:
two upstanding hollow posts, each being generally U-shaped in cross section and including two side plate portions and an intermediate plate portion interconnecting said two side plate portions, said two side plate portions cooperatively defining a substantially vertical elongate opening;
at least one hollow hanging bar having an inner space therein and two end portions;
a fastening unit detachably connecting each of said two end portions of said hollow hanging bar to one of said side plate portions of a respective one of said hollow posts; and
an electric heater including a heating wire inserted in said inner space of said hollow hanging bar so that said hollow hanging bar can be heated via said heating wire.

2. The towel rack of claim 1, wherein said one of said side plate portions of each of said hollow posts connected to said hollow hanging bar includes at least one through hole, and a flange plate that is proximate to said elongate opening and that protrudes into the respective one of said hollow posts, each of said end portions of said hollow hanging bar extending through said through hole and being connected to said flange plate via said fastening unit.

3. The towel rack of claim 2, wherein said flange plate is formed with at least one first fastening hole, each of said end portions of said hollow hanging bar being formed with a second fastening hole, said fastening unit being inserted into said first and second fastening holes.

4. The towel rack of claim 3, wherein each of said end portions of said hollow hanging bar is formed with a notch for engaging said heating wire.

5. The towel rack of claim 1, further comprising two substantially vertical lids, each spanning said elongate opening of a respective one of said hollow posts, each of said vertical lids including a lid plate disposed between and engaging slidably said side plate portions of the respective one of said hollow posts to cover said elongate opening of the respective one of said hollow posts, and a handling portion projecting transversely from said lid plate and outwardly from said elongate opening of the respective one of said hollow posts, said handling portion being operable to slide said lid plate vertically relative to said side plate portions of the respective one of said hollow posts and to uncover said elongate opening of the respective one of said hollow posts.

6. The towel rack of claim 5, wherein each of said vertical lid plates includes two first slide members, each of said side plate portions of each of said hollow posts including a second slide member, said first slide members of each of said vertical lid plates slidably and respectively engaging said second slide members of said side plate portions of a corresponding one of said hollow posts.

7. The towel rack of claim 6, wherein one of said first and second slide members is a male slide member, and the other one of said first and second slide members is a female slide member.

8. The towel rack of claim 6, wherein each of said vertical lid plates has two vertical ends, each of said first slide members being a slide ridge formed at a respective one of said two vertical ends of a respective one of said vertical lids, each of said second slide members being a slide groove formed proximate to said elongate opening of a respective one of said hollow posts.

9. The towel rack of claim 1, wherein each of said hollow posts further includes two cover plates to respectively cover top and bottom open ends of said hollow post.
